(19) United States
(12) Patent Application Publication
(10) Pub. No.: US 2017/0024399 A1
(43) Pub. Date: Jan. 26, 2017

(54) A SYSTEM AND METHOD OF TRACKING MUSIC OR OTHER AUDIO METADATA FROM A NUMBER OF SOURCES IN REAL-TIME ON AN ELECTRONIC DEVICE

(71) Applicant: SPOTIFY AB, Stockholm (SE)

(72) Inventors: Brian Boyle, Dublin (IE); Dave Lynch, Dublin (IE); George Boyle, Dublin (IE); Brendan O'Driscoll, Dublin (IE); Craig Watson, Dublin (IE); Aidan Sliney, Dublin (IE)

(21) Appl. No.: 15/301,694

(22) PCT Filed: Apr. 2, 2015
(86) PCT No.: PCT/EP2015/057322

§ 371 Date: Oct. 3, 2016

Related U.S. Application Data
(60) Provisional application No. 61/974,453, filed on Apr. 3, 2014.

(51) Int. Cl. G06F 17/30; H04W 4/02

(52) U.S. Cl. CPC G06F 17/3074; G06F 17/30964; G06F 17/30749; H04W 4/02; H04L 67/18

(57) ABSTRACT

The present invention relates to a system and method tracking music or other audio metadata from a number of sources in real-time on an electronic device and displaying this information as a unified music feed using a graphical and textual interface. In one embodiment the invention provides a system and method for sharing such information within a social network or other conveyance system in order to aggregate crowd sourced, location-based and real-time information by combining the location, timestamp and metadata of user's listening history on such an electronic device.

### FIELD

The present invention relates generally, as indicated, to a system and method tracking music or other audio metadata from a number of sources.

### BACKGROUND

As the proliferation of electronic devices continues, there is now also a huge diversity in the number of features and accessories associated with such electronic devices. More specifically, many electronic devices have video playback capability, audio playback capability and image display capability. Exemplary accessories may also include headphones, music and video input players, etc. Taken together, the above features and accessories are often used by owners of electronic devices to store, stream and listen to a range of audio and music related media, which can then be consumed, by the owners at any time and/or location.

To match this ever-growing demand by consumers to store, stream and listen to a range of audio and music media, a number of digital music content providers have emerged over the past decade. Following the introduction of downloadable digital music files, the music industry evolved from the peer-to-peer network platforms which facilitated the illegal sharing of such files for free (eg Napster and Kazaa) to fully licensed alternatives (eg iTunes). The next significant evolution in digital music occurred as web based internet radio providers offered listeners the ability to listen to music online (eg Pandora Radio). Music subscription services then emerged as a means for users to consume large libraries of music for a flat subscription fee (eg Rhapsody and Spotify).

As a result of the ever-changing mediums that consumers use to listen to digital music, the music space is severely fragmented with users divided between downloading music (both legally and illegally), streaming through internet based radio stations and/or using online subscription services. Accompanying this fragmentation is the overwhelming song choice that consumers now face as there are over 20 million tracks available on most of the established content providers. This means that consumers are becoming increasingly confused by both the number of content providers available and the amount of music that is available to consume.

In order to combat this ‘search bar paralysis’ when looking for music, a number of services have been introduced which have tried to tackle the problems of discovering music in such a disjointed environment. Traditionally, such services have concentrated on analysing the listening history of a user and providing recommended artists based on a recommender system. Sentimental analysis has also been used to filter music listening habits based on the time of day or mood of the consumer for example. These approaches neglect the human curation side of music discovery.

Furthermore, the lack of interoperability means that a user is unlikely to use the same content provider as their friends which limits the amount of social interactivity between the two parties. In the current state of the art, it is therefore increasingly difficult to share audio and music content information with your friends due to the fragmented nature of the industry.

Existing content providers may offer a social music discovery tool; however, the content that is shared on such services is limited to users of that particular service. The music service that provides for the sharing of content is typically also in control of the actual music content. Akin to a toll bridge type business, such content providers facilitate the movement of traffic provided it is through its own gateways. Users must therefore pay the toll in order to benefit from the full service. This results in a rather limited and sandboxed experience for the user who can only discover the music listening habits of other users on that same platform.

It is therefore an object of the present invention to provide a new and improved system and method of tracking music and/or other audio metadata.

### SUMMARY

The present invention, as set out in the appended claims, relates to a system and method tracking music or other audio metadata from a number of sources in real-time on an electronic device and displaying this information as a unified music feed using a graphical and textual interface, and more particularly, to sharing such information within a social network or other conveyance system in order to aggregate crowd sourced, location-based and real-time information by combining the location, timestamp and metadata of user's listening history on such an electronic device.

Many owners of portable electronic devices have their own collection of music which is often sourced from a variety of different locations and music services including, but not limited to mp3 files, mp4 files, other downloads and streaming services. It is very common for electronic devices to be used in a manner that allows the user to side load their music, to store it and play such music. The metadata related to the playing of such audio and music content is therefore accessible as it sits agnostically on an electronic device.

The invention specifically targets this information through a system and method which interacts with a user's electronic device and is able to access this metadata at the time of playing the content so that we can know what music or other audio content that people are actually listening to in real-time.

Furthermore, the invention can access this metadata from a number of sources including native music players on the electronic devices, third party music players, internet radio and streaming services. The invention is not therefore limited to tracking the music or other audio metadata of any one content provider. The invention allows for a more holistic view of what people are listening to across a range of platforms on their electronic devices. In turn, this unified feed is displayed in a graphical and textual interface so that the user can easily see what other listeners within their network are listening to.

In addition, once a song or other audio metadata has been played by a user, it is now possible to determine the location of the electronic device through the use of either GPS, wireless triangulation and system networks or a combination of same. This means that it is also possible to locate the location of where a song or other audio metadata is played on an electronic device. Despite this advance in technology, traditional music services tend not utilise this location-based information when sharing content between users.

It is also possible to know the exact timestamp of when a song or other audio metadata is played on the majority of electronic devices. Often this information is then relayed on the music services' social network or other conveyance system to other users of the music service. However, this real-time application of the listening habits of an individual user is not often used in the aggregate to see what a group of people have been listening to over a specific time frame (eg in the last hour, during the previous week or over the course of a year).

Accordingly, there exists a need for a system and method for sharing information about music or other audio metadata which is extracted from an electronic device that remains independent and which sits agnostically above any particular music service. This will in turn allow for the aggregation of crowd-sourced listening habits of users by combining the location, timestamp and music or other audio information of multiple users' listening histories in order to display a unified music feed to assist in the music discovery process.

The present invention is an improvement over conventional systems in that the system and method for tracking music or other audio metadata from a number of sources in real-time on an electronic device and displaying this information as a unified feed using a graphical and/or textual interface is both unique and an improvement over the prior art.

There is also provided a computer program comprising program instructions for causing a computer program to carry out the above method which may be embodied on a record medium, carrier signal or read-only memory.

It is therefore an object of the present invention to provide a new and improved system and method of tracking music or other audio metadata that allows users to actually see what their friends and family are listening to as they listen to their music (on their platform of choice).

It is another object of the present invention to provide a new and improved tracking system and method that displays this information as a unified feed and in an efficient manner targeted to users who are the most likely to be interested in the information.

It is yet another object of the present invention to provide a new and improved tracking system and method that allows mobile users to use the system by way of multiple platforms and across multiple content providers.

It is still yet another object of the present invention to provide a new and improved tracking system and method that is capable of working with real-time GPS location-based systems as well as pre-loaded mapping software.

It is still yet another object of the present invention to provide a new and improved tracking system and method that is capable of working with temporal-based systems so that users can search and filter this information by time.

It is another object of the present invention to provide a new and improved tracking system and method using a graphical and textual interface to facilitate the discovery of new music.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

The invention will be more clearly understood from the following description of an embodiment thereof, given by way of example only, with reference to the accompanying drawings, in which:

FIG. 1. is a diagram of a system for tracking played content on an electronic device.

FIG. 2 is a schematic view of one embodiment of the content sources that are being tracked.

FIG. 3 is a diagram of the server to client interaction that is used to implement an embodiment of the invention.

FIG. 4 is a schematic view of one embodiment of how the service tracks content on the Android platform.

FIG. 5 is a schematic view of one embodiment of how the service tracks content on the iOS platform.

FIG. 6 is an example of songs tracked on a specific user's profile displaying this information as a unified feed using a graphical and textual interface.

FIG. 7 is an example of the activity feed illustrating a song capture from the native music player on an Android phone.

FIG. 8 is an example of the activity feed illustrating a song capture from the Spotify streaming service.

FIG. 9 is an example of the activity feed illustrating a song capture from a video streaming service (eg YouTube).

FIG. 10 is an example of the activity feed illustrating a song capture from the native music player on an iPhone.

FIG. 11 is an example of the activity feed on a user's profile illustrating what songs they have been playing.

FIG. 12 is an example of the top played chart on a user's profile illustrating what songs the user has been playing the most.

FIG. 13 is an example of the shared activity on a user's profile illustrating what songs have been shared to the user.

FIG. 14 is an example of a global chart illustrating what songs have been played the most by all users on the app.

FIG. 15 is an example of a global chart illustrating what songs have been liked the most by all users on the app.

FIG. 16 is an example of a global chart illustrating what songs have been disliked the most by all users on the app.

FIG. 17 is an example of a song card and the corresponding YouTube video for the relevant song tracked.

FIG. 18 is an example of a song card and the corresponding streaming content for the relevant song tracked.

FIG. 19 is an example of a song card and the corresponding purchase link for the relevant song tracked.

FIG. 20 is an example of the share functionality which allows a user to share tracked content with other users in the conveyance system.

FIG. 21 is an example of the notification centre which allows a user to distinguish what action have occurred with other users in the conveyance system.

FIG. 22 is a schematic view of one embodiment of how the service tracks content through desktop players.

FIG. 23 is an example of the desktop illustrating a song capture on the Goole Play Music platform.

### DETAILED DESCRIPTION OF THE DRAWINGS

A system and method of tracking music or other audio metadata from a number of sources in real-time on an electronic device and displaying this information as a unified feed using a graphical and textual interface is disclosed.

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

Although several embodiments of the invention are discussed with respect to music or other audio metadata at different devices and from different content sources, in communication with a network, it is recognized by one of ordinary skill in the art that the embodiments of the inventions have applicability to any type of content playback (eg video, books, games) involving any device (wired and wireless local devices or both local and remote wired or wireless devices) capable of playing content that can be tracked, or capable of communication with such a device.

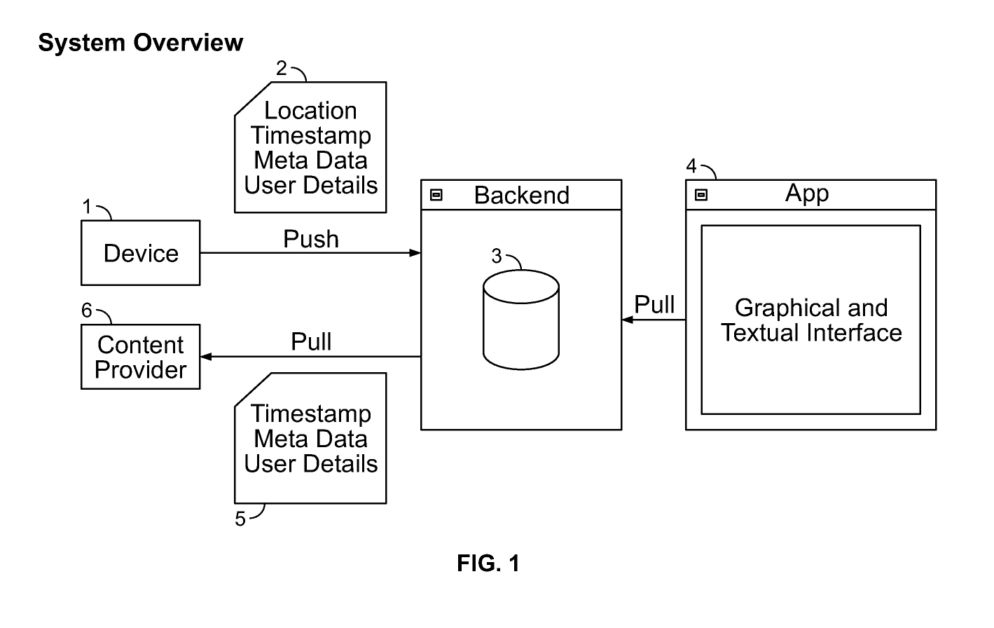

FIG. 1 is a diagram of a system for tracking played content on an electronic device, according to one embodiment. In various embodiments 1 can be any type of fixed terminal, mobile terminal or portable terminal including desktop computers, laptop computers, handsets, stations, units devices, multimedia tablets, personal digital assistants, cell phones or any combination thereof. Moreover, the device 1 may have a hard-wired energy source (eg a plug-in power adapter), a limited energy source (eg a battery) or both. It is further contemplated that the device 1 can support any type of interface to the user. By way of example, the communication between push of location, timestamp, metadata and user details at 2 between the device 1 and the backend 3 and the communication between the pull of location, timestamp, metadata and user details at 5 between the backend 3 and the content provider 5 can include one or more networks such as a data network (not shown), a wireless network (not shown), a telephony network (not shown) or any combination thereof. It is contemplated that the data network may be any local area network (LAN), metropolitan are network (MAN), wide area network (WAN), the Internet, or any other suitable packet-switched network. In addition, the wireless network may be, for example, a cellular network and may employ various different technologies including code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS) as well as any other suitable wireless medium (eg microwave access (WiMAX), Long Term Evolution (LTE) networks, wireless fidelity (WiFi), satellite and the like.

The system set out in FIG. 1 includes a music tracking service 1, 2,5 and 6 and a database interface process 3. The system includes instructions for finding metadata about music or other audio files. The database interface process 3 is the interface between the device 1 and the content database 6, and is used to retrieve and store metadata, and to retrieve and store content.

In the illustrated embodiment, the services include played content tracker process 2 and 5 to track plated music or other audio metadata and to use the database interface process 3 to store and retrieve the event data that describes what is being played, where it being played and when.

In step 2, the event generator process detects the initial operation of the device, such as during power up or movement to a cell of a different base station or access point. An event geolocation message is sent for receipt by the content service system. The geolocation event message indicates the geographic location of the mobile device, determined in any manner known in the art. For example, in some embodiments, the mobile terminal includes a Global Positioning System (GPS) receiver and logic to determine the geographic location of the mobile terminal. In some embodiments, geolocation message is omitted.

In some embodiments of 2 and 5 the user ID field 2 and 5 may be used, such as a node identifier for the device used for playback, a user supplied name, an email address or an ID assigned to a user who registers with a content service system (eg Facebook). In steps 2 and 5, the timestamp field is also retrieved which holds data that indicates when the event occurred on the device that plays the content. In some embodiments, the timestamp is omitted. The content duration field (not shown) in steps 2 and 5 holds data that indicates the time needed to play the content fully for appreciation by a human user. This field in certain embodiments can be omitted. The content ID in steps 2 and 5 holds data that uniquely identifies the content being played (eg the music or audio metadata). In some embodiments, the field holds data that indicates a name of the content and a name of an artist who generated the content, such as song title and singer name. This content ID, if a music file, often contains the genre of the music played together with the song duration and other related metadata.

In circumstances where the music or audio metadata is not stored on the device 1, and pushed 2 to the database 3, often a Content Distribution Network (CDN) as embodied in 6 is the source of the music or audio metadata. Typically, the music store authorizes the CDN to download the client and then directs a link on the user's browser client to request the content from the CDN. The content is delivered to the user through the user's browser client as data formatted, for example, according to HTTP or the real-time messaging protocol (RTMP). As a result, the content is stored as local content 6 on the user's device 1. The local content arrives on the device either directly from the CDN or indirectly through some other device (eg a wired note like other host) using a temporary connection (not shown) between mobile terminal for example and other host.

Once this information has been added to the database 3 and stored locally, the application itself 4 on a user's mobile device can then be used to access and retrieve the music or other audio metadata in a graphical and textual interface. Depending on the availability of the location, metadata, user details and timestamp, the user can then distinguish what music or other audio file was played, when it was played, where it was played and by whom.

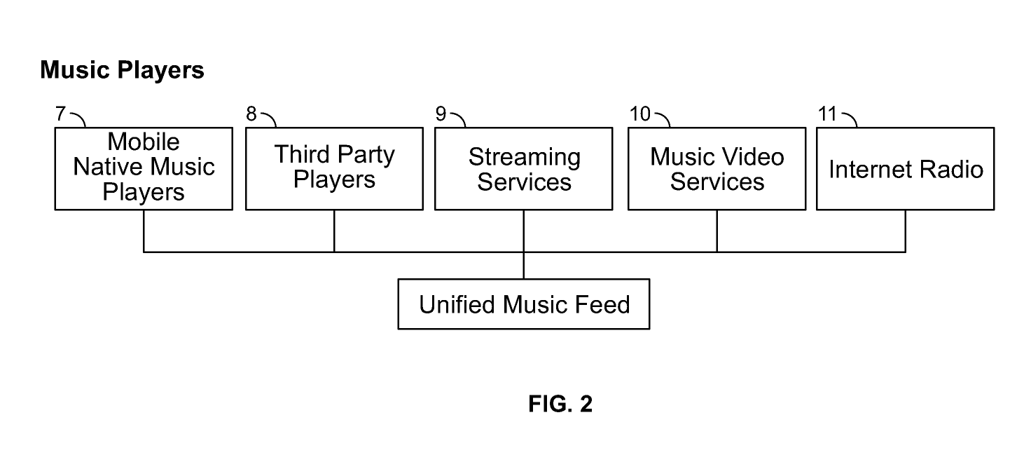

FIG. 2 is a schematic view of one embodiment of the content sources that are being tracked. As set out above, the music or other such metadata can be sourced from either the device 1 itself or from a content provider 6. FIG. 2 therefore sets out the different embodiments that can be used in the current art to source such metadata. This includes, but is not limited to, the native music players (eg the Android native music player or the iOS native music player) 7. Furthermore, a user may listen to the songs stored on their device 1 using a third party application (eg Songbird) which works as both a web app and a bespoke mobile app for both Android and i0S. In addition, a user may source their music or other audio metadata from a streaming service 8 or video service 9 which provides music on demand (eg Spotify). The system in FIG. 1 has been created in such a manner so that it can also track what music or other audio metatdata is played using music video services 10 (eg YouTube). Finally, internet radio 11 content can also be tracked using the service. The resulting content can then be stored in a unified music feed 12 and displayed in a graphical and textual interface on the application 4.

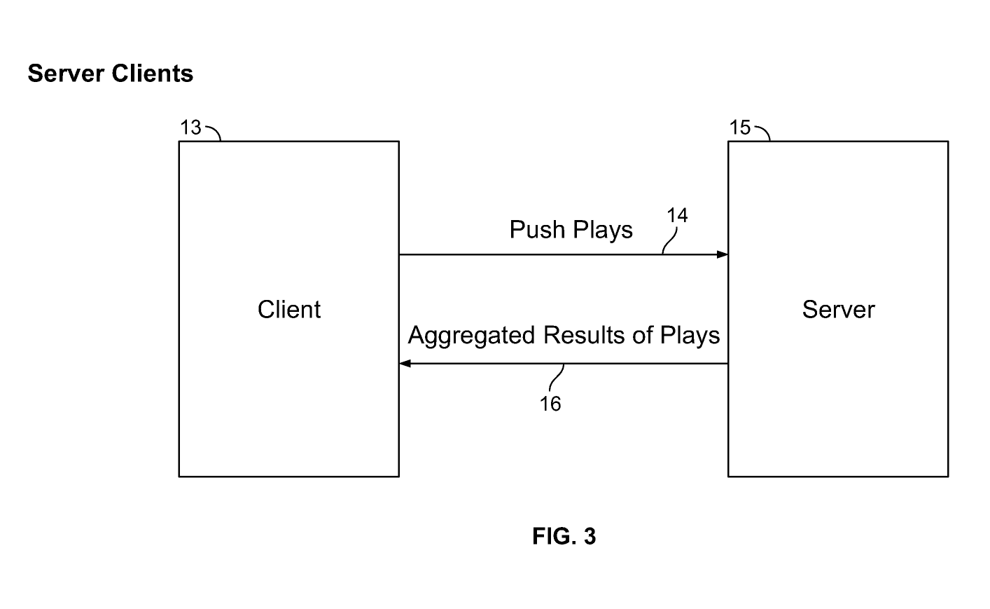

FIG. 3 is a diagram of the server to client interaction that is used to implement an embodiment of the invention. The client-server model of computer process interaction is widely known and used. According to the client-server model, a client process 13 sends a message including a request to a server process 15, and the server process responds by providing a service. The server process 15 may also return a message with a response to the client process 13. Often the client process and server process 15 execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” 13 and “server” 15 refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. In this case, the client 13 pushes plays 14 to the server which then returns the aggregated results of the plays 16 back to the client 13.

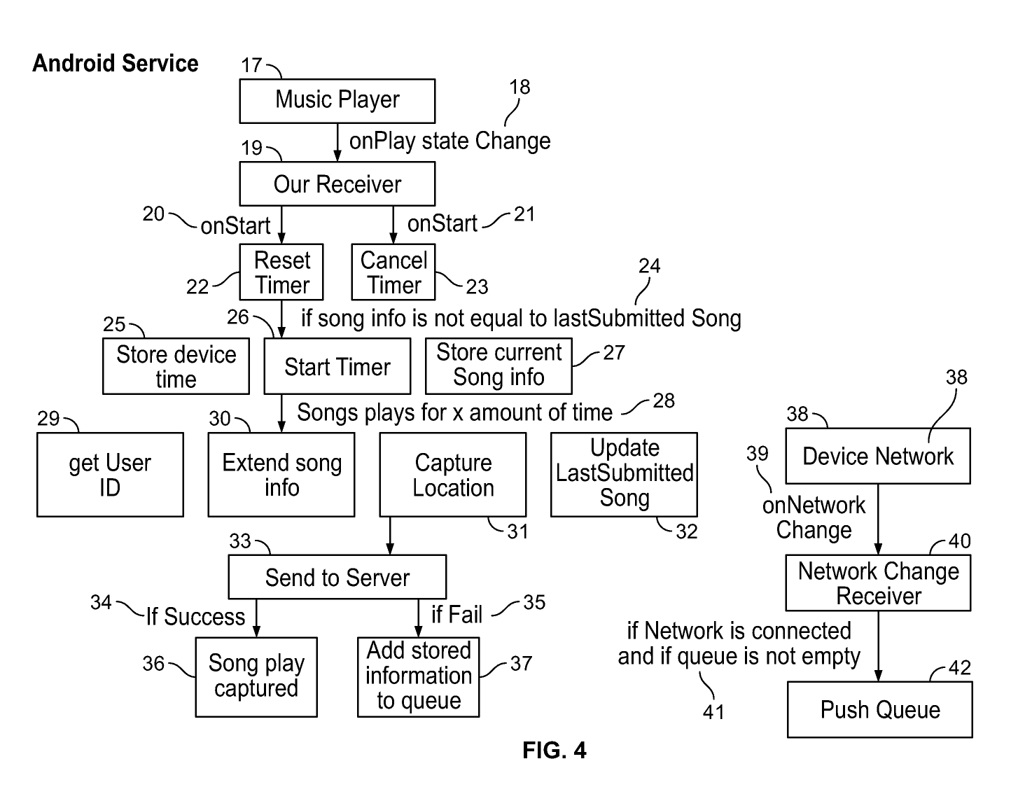

FIG. 4 is a schematic view of one embodiment of how the service tracks content on the Android platform. Taking an example of where the current embodiment is a mobile device, the event begins when the music player 17 is enabled into an onPlay state change 18. This then sends across the respective music or other audio metadata to a receiver 19. In step 20, the system then recognises an onStart state change 20 and the timer is reset 22 as a means of ensuring that new music or other audio metadata begins at a zero count so that step 28 can be queried correctly. Equally, if there is an onStop state change, the timer is cancelled so that the current music or other metadata is not pushed towards a server 33. Step 28 refers to a timer commences on the playback of the content to assess if the metadata has been played for the requisite amount of time. This ensures that only songs that meet the predetermined criteria for a play are tracked. Assuming that the song info is not equal to the last submitted song 24, and that the song plays for the requisite amount of time 28, the device time is stored 25 to assist in providing the timestamp as outlined for either step 2 and 5. Also, the timer starts again to track the song play duration 26. Furthermore, the current song info is stored 27. If the song plays for the requisite amount of time in step 28, then the extended song info is queried 30 to check the genre of the music or other audio metadata. Such extended song info 30 is retrieved from the device itself 1. In the next steps, the service then retrieves the user ID 29 and captures the location 31 as outlined previously in either step 2 or 5. This information is then sent to a server 33. Depending on the network connectivity being available, the song play is then captured 36. If the service fails 35, the information is stored and sent to a queue 37 to be pushed at a later point in time.

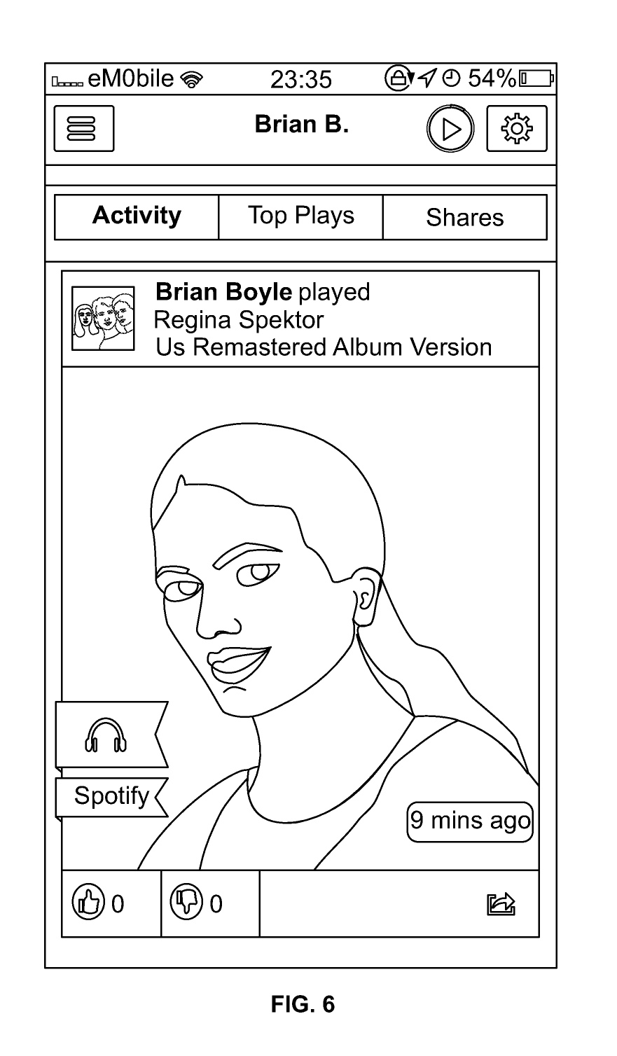

In circumstances where the device network 38 changes as set out in step 39, the system acknowledges this through a network change receiver 40. Assuming that the network is connected 41 and that there are songs stored in the queue 37, the queue is then pushed in step 42 and the song play is captured as outlined in step 36. The result for a user is that the music or other audio metadata played is tracked by the system and shows up in their activity feed within the application 4. A visual representation of this is set out in the example of a user's activity feed in FIG. 6. In addition, the overarching effect of a user's song capture 36 is that this can then be aggregated and stored in a database 3 to be displayed using a graphical and textual interface 4 through a unified music feed on the application 12.

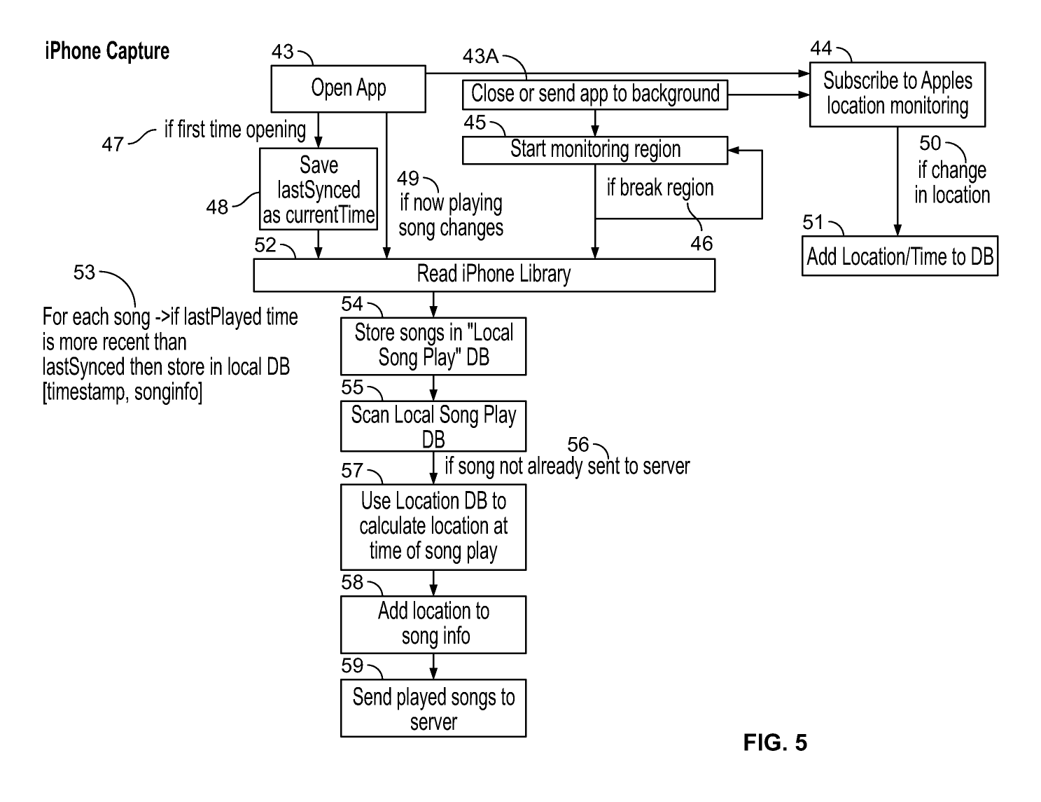

FIG. 5 is a schematic view of one embodiment of how the service tracks content on the iOS platform. Taking an example of where the device 1 is a mobile device, the service begins with one of three possible events (a) either the application is opened 43 for the first time (b) is opened for a second or subsequent time or (c) in cases when the app is closed or dormant in the background 43A.

If the app is opened for the first time 47 the service saves the last synced as the current time 48. The next step involves the iPhone library being read 52 to query what the last played songs have been in the phones library and proceeds to step 53 described below.

If the app is opened (any time after being opened for the first time), the service then checks what the now playing song is and if this has changed 49. If it has, then the service reads the iPhone library 52 and proceeds to step 53 described below.

If the app is closed or if the app is dormant in the background 43A, the service will start monitoring the region 45 of the device 1. If and when the user then breaks the region as outlined in step 46, the service assesses if the now playing song has changed since the last query 49. If the now playing song has changed 49, the service reads the iPhone library 52 and proceeds to step 53 described below. If the now playing song has not changed, the service does not proceed again until the user breaks the region that is being monitored 46. This step will reoccur until the now playing song actually changes.

In addition, according to another embodiment the service subscribes to Apple's location monitoring 44 and if there is a change in location 50, the location and time of this change is added to the location database 51 which is then used to append location to the song play 58 in advance of being sent to a server 59.

For every song queried on the iPhone library, if the last played time is more recent than the last synced 53 then it is stores in the local database 54. An example of this would be when the last sync takes place at 11 am. If the last played song is tracked at 1 pm (which is two hours after the last sync), then we store this song in the Local Song Play DB 55. Taking another example, if the last played song is tracked at 10am, then the song will not be stored in the Local Song Play DB 55 as the last sync occurred later than the last played song. The next step involves a scan of the Local Song play Database 55 and if this song has not already been sent to the server 56 it will be sent to the server 59. As outlined above, before step 59, the system uses the location database to calculate the location at the time that the song was played 57. If this query is successful, we then add location to the song information 58. For the purposes of this FIG. 5, song metadata is just one embodiment of the type of metadata that can be tracked on iOS as this could apply equally to audio files etc. The result for a user is that the music or other audio metadata played is tracked by the system and shows up in their activity feed within the application 4. A visual representation of this is set out in the example of a user's activity feed in FIG. 6. In addition, the overarching effect of a user's song capture 36 is that this can then be aggregated and stored in the database 3 to be displayed using a graphical and textual interface 4 through a unified music feed on the application 12.

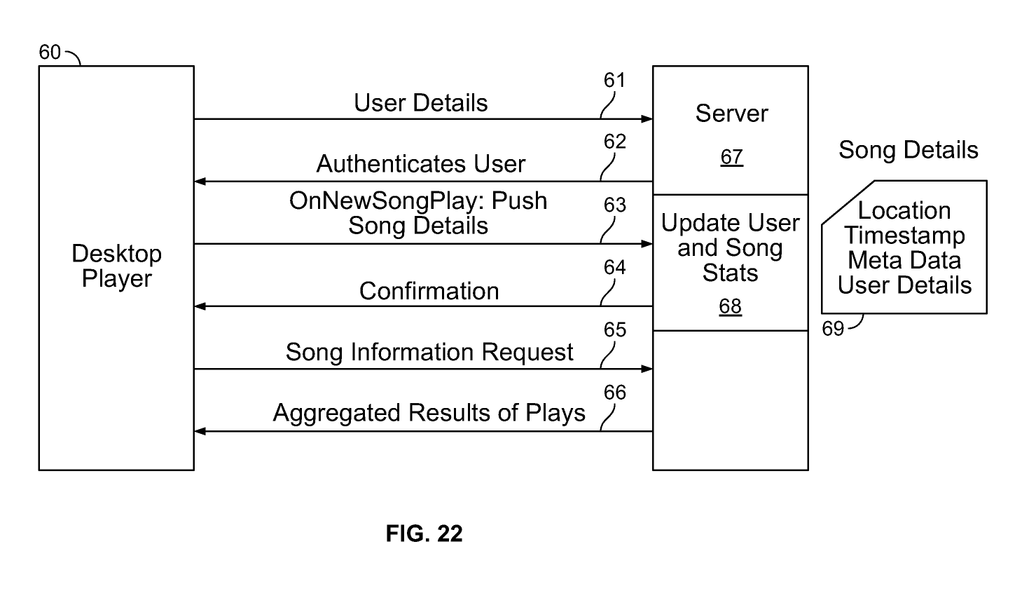

FIG. 22 is a schematic view of one embodiment of how the service tracks content on desktop players. The event begins when the user details 61 are sent across to the server 67 and are authenticated 62. If the desktop player 60 is enabled into an onPlay state change then the song details are then transmitted to the server 67. A confirmation request is then pushed by the server 64 that then relays the song information request 65 which provides an aggregated result of all plays on the desktop 66. The server updates the user and song stats 68 based on the song details provided (location, timestamp, metadata and user details) 69. This ensures that song captures from the desktop device are synced with any other song captures from mobile devices for example and ensures that a users entire listening history is captured irrespective of whether the song is listened to on a desktop or mobile device.

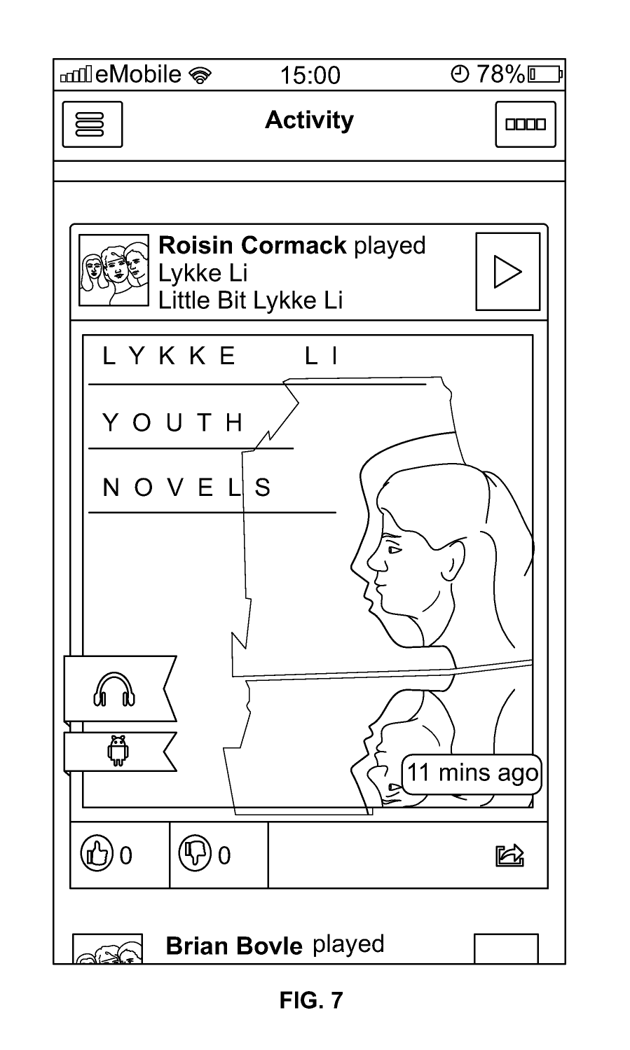

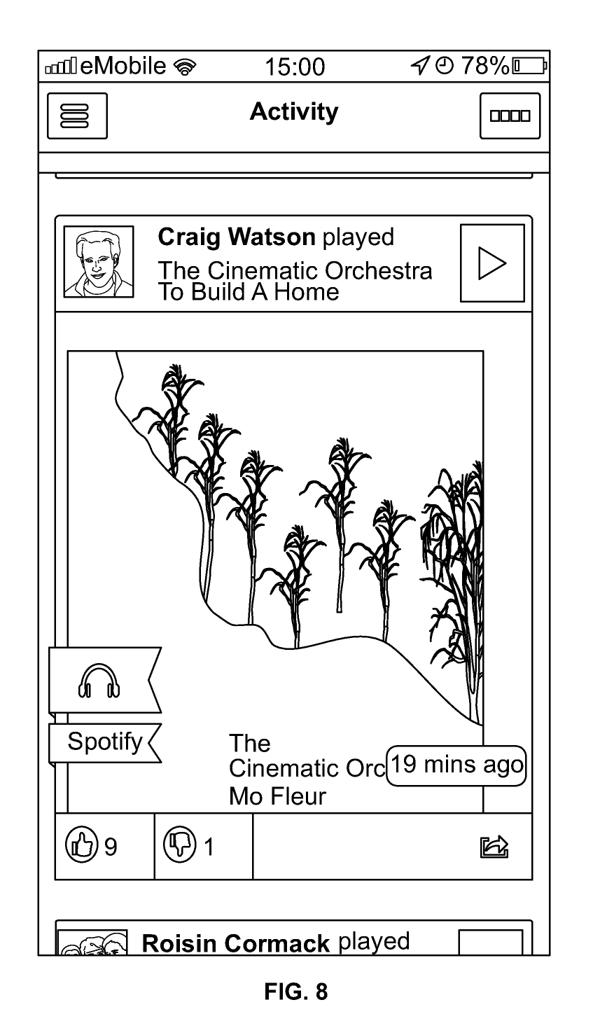

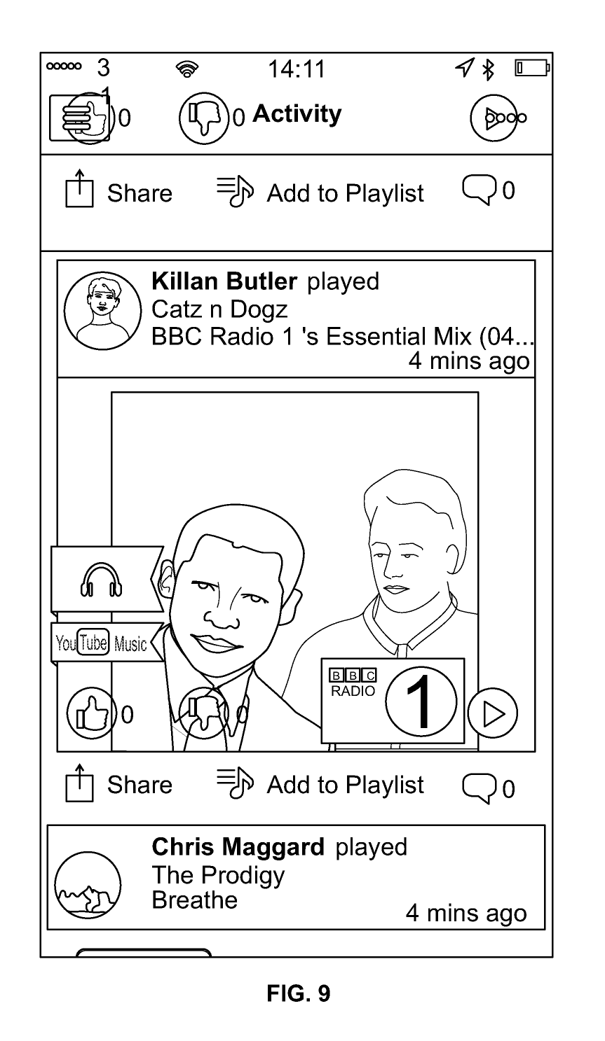

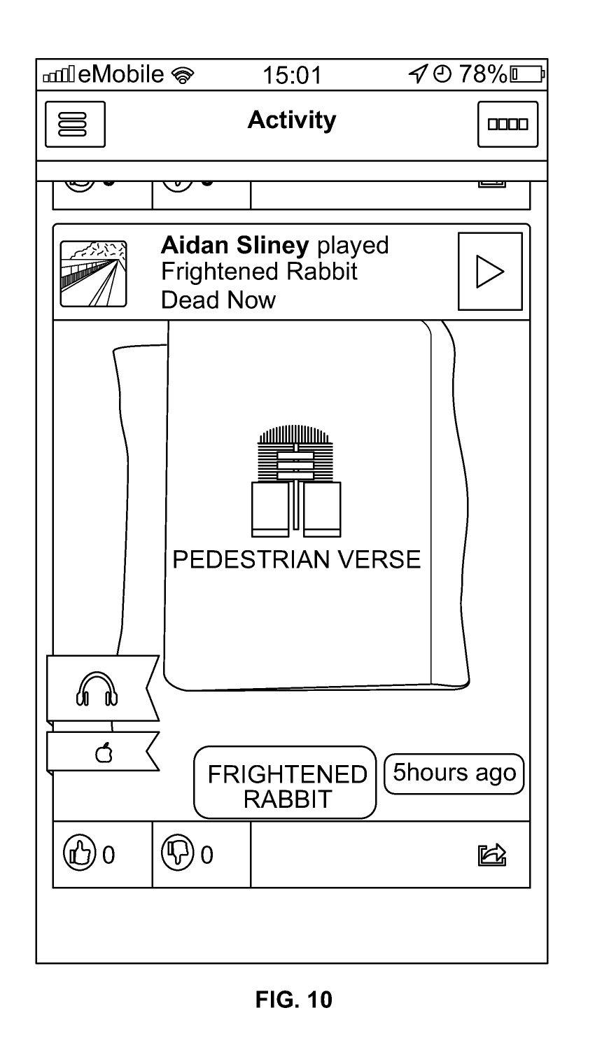

Referring now to FIGS. 6 through 10, a plurality of screenshots illustrating one embodiment of point of information exchange through a unified music feed 12 to allow a user to both share their own information and music listening history with others and in particular, it is appreciated that the system may also permit a user to browse or search the content information stored in and/or available through the unified music feed. Through the point of interest exchange, which preferably is incorporated into the system in real time for access by others, users may review the unified music feed and see what music or other audio metadata has been tracked across various sources. In FIG. 7 for example, the song ‘Little Bit’ by Lykke Li was played and captured on an Android native music player (as indicated by the graphical source flag on the song card). In FIG. 8, the song ‘To Build A Home’ by the Cinematic Orchestra was played and captured on a streaming service (eg Spotify in this case). FIG. 9 illustrates the capture of a song from a video service, in this case YouTube. Finally, FIG. 10 is an example whereby the song ‘Dead Now’ by Frightened Rabbit was captured on the iPhone's native music player as indicated by the source flag on the song card itself. The result of displaying these song plays using a graphical and textual interface 4 is that it is easy to distinguish the source of where the metadata has been played.

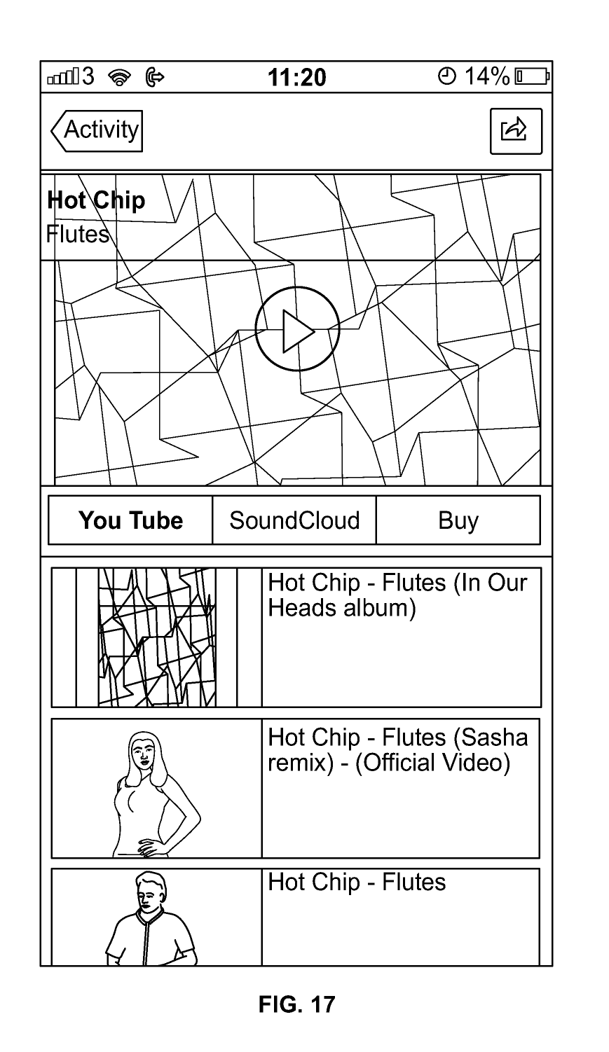

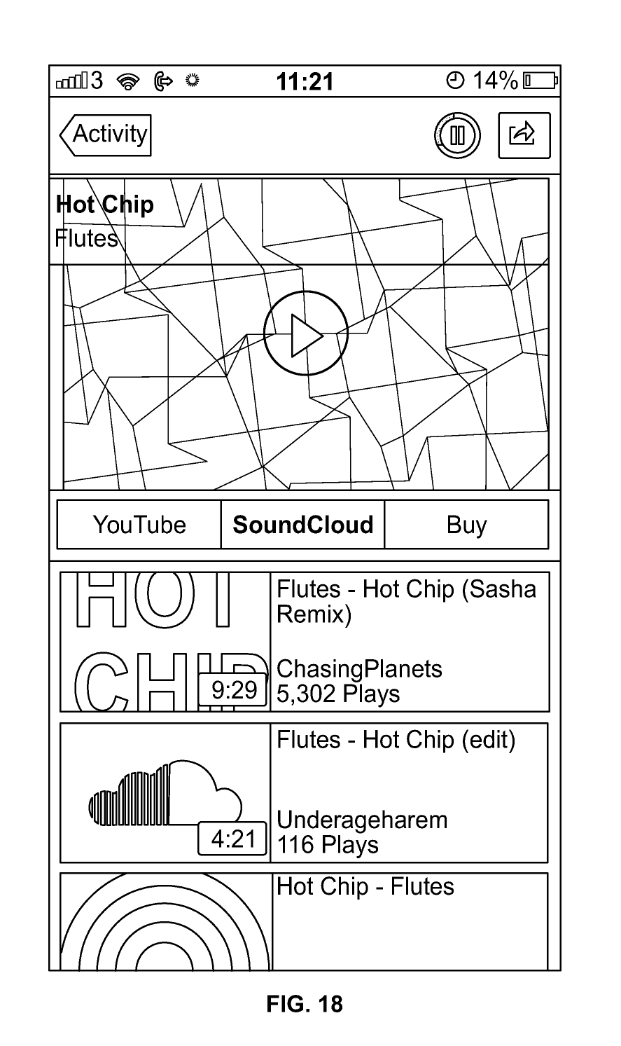

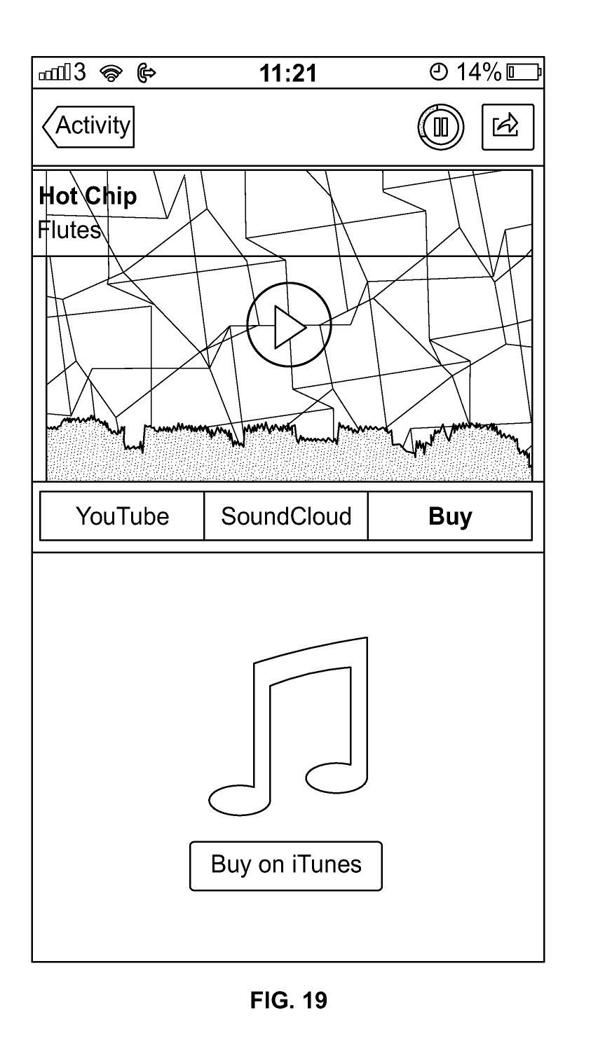

Furthermore it should be noted by reference to FIGS. 6 through 10 that the various songs listed (and sourced from different content providers and platforms) can then be consumed on the application 4 using a 30 second preview or by clicking into the song itself as illustrated in FIG. 17 and watching the YouTube video or streaming the song from one of our API partners as illustrated in FIG. 18. Thus a user can discover songs from friends on other platforms on the activity feed, as shown in FIG. 7 and listen to them all within the application 4. In addition, a user can purchase the song from a number of content providers as set out in FIG. 19. In this example, a user can buy the song ‘Flutes’ by Hot Chip on the iTunes store.

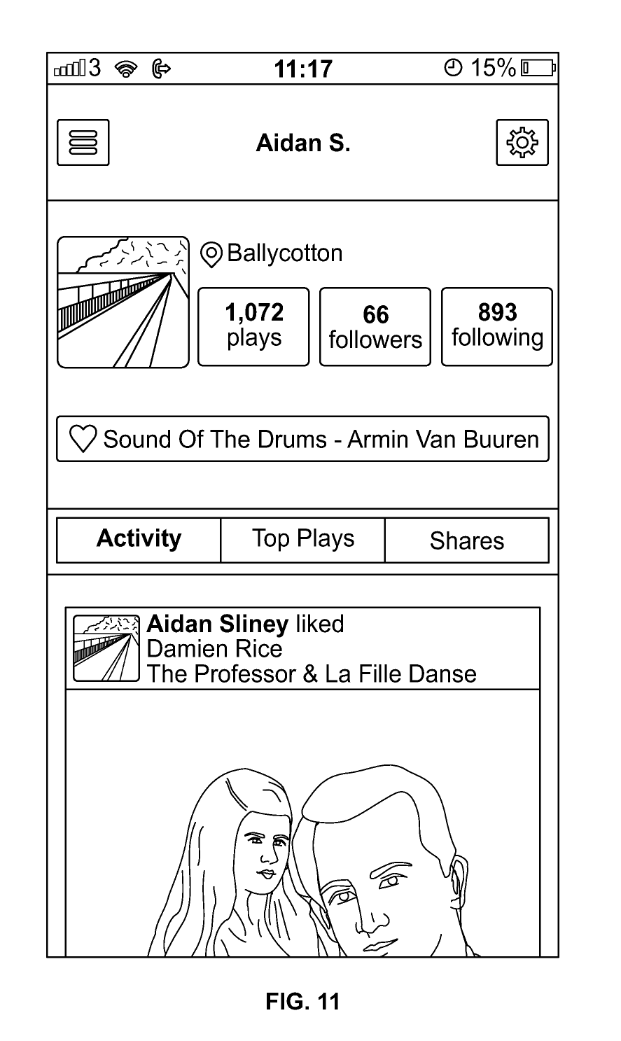

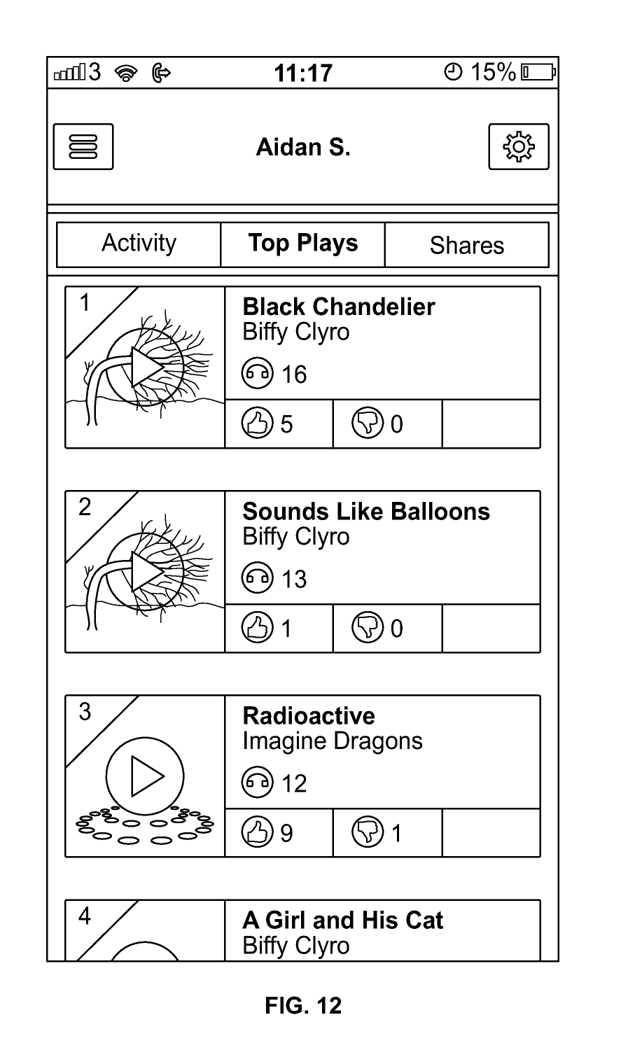

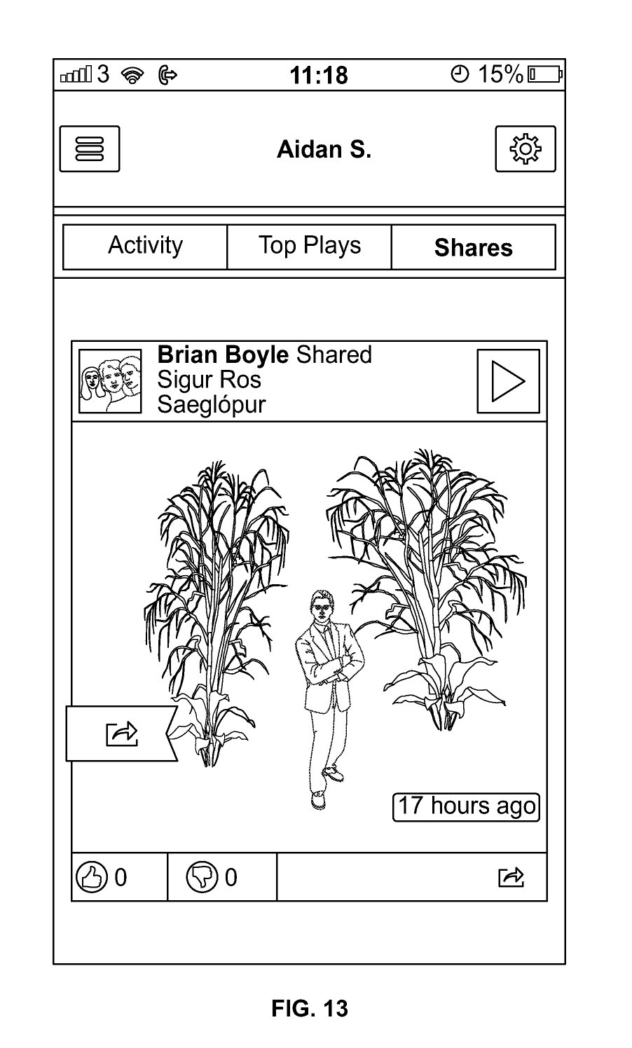

FIG. 11 another embodiment of the present invention illustrates how a user can check his/her own activity to see what music or other audio metadata has been played recently and when this has been played. A user can equally check what his/her top played songs are since the service was downloaded as illustrated in FIG. 12. In addition, a user can see what music or other audio metadata has been shared both to the user and from the user within the application by viewing the shared tab as illustrated in FIG. 13. The social network and conveyance system is also represented in FIG. 11 as it is clear for a user to asses who he/she is following and who is following the user in return.

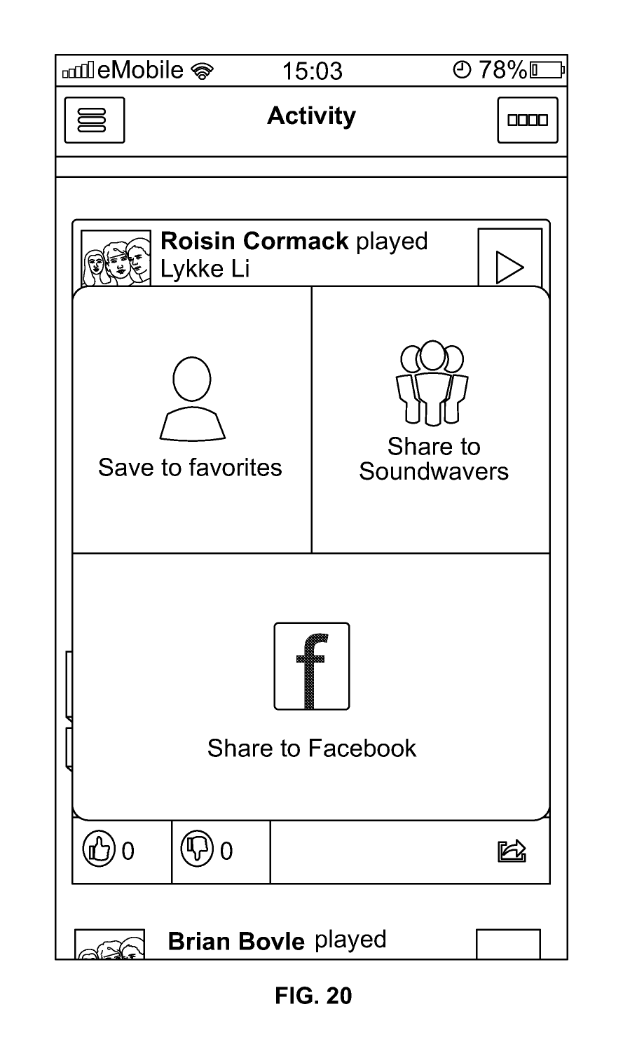

It is through this social network and conveyance system that a user can also is share any music or other audio metadata as outlined in FIG. 20. This information can be saved to themselves (to be consumed at a later date), to another member of the application or to a third party (eg Facebook).

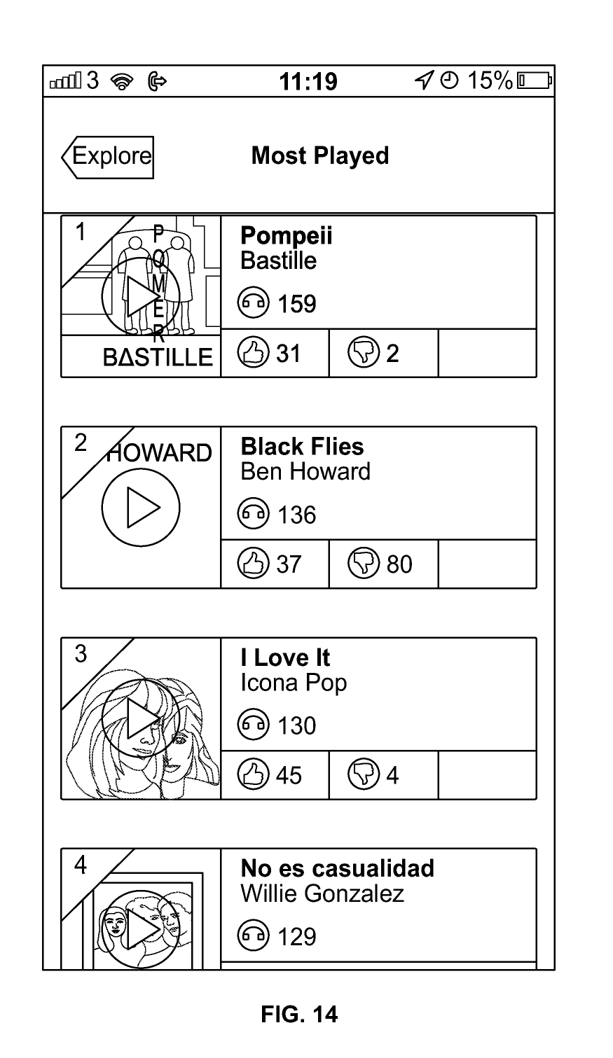

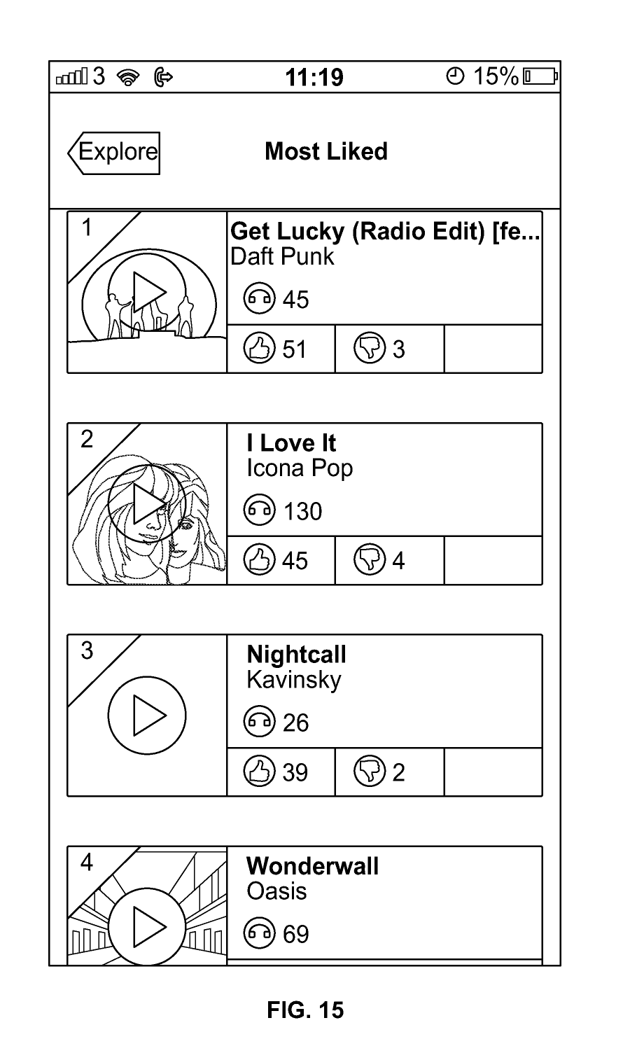

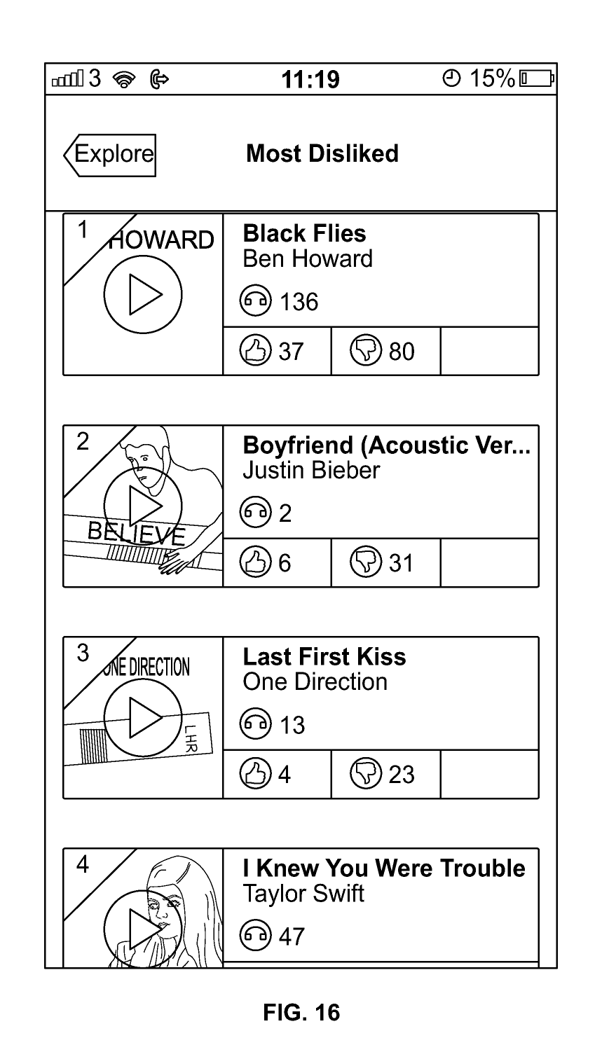

Referring now to FIGS. 14 through 16, a plurality of screenshots illustrating one embodiment of point of information exchange based on the aggregation of the most played songs on the application 4 using a bespoke chart for this. The present embodiment takes the form of a top 20 chart as illustrated in FIG. 14 but variations of this embodiment can occur so that you could, for example, have most played charts filtered by genre, time, user ID and location. Furthermore, users are provided with a mechanism on the application 4 to rate the music or other audio metadata that is tracked and displayed using a thumb up and thumbs down icon. One application of this embodiment is that it is therefore possible to have ‘rated’ charts which display the most liked songs and most disliked songs for example. FIG. 15 is an example of a most liked chart. FIG. 16 is an example of a most disliked chart.

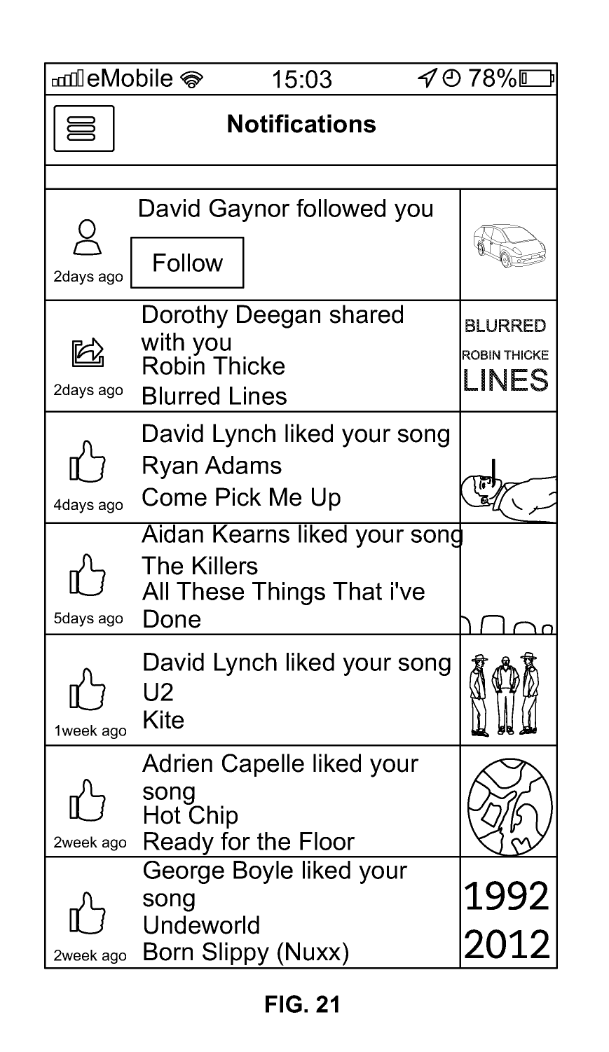

Referring now to FIG. 21, another embodiment of the present invention is shown. In particular, it is appreciated that the system may also permit a user to synopsise what activity they have been tagged in on the application using a notification centre. Such notifications help put the user on notice that a song they played (and which was tracked by the service) was liked or disliked by another user on the app or that a user shared a particular song with them. This embodiment enhances the social experience of the application for the user while also providing a clear conduit to interact with a user's captured music or other audio metadata.

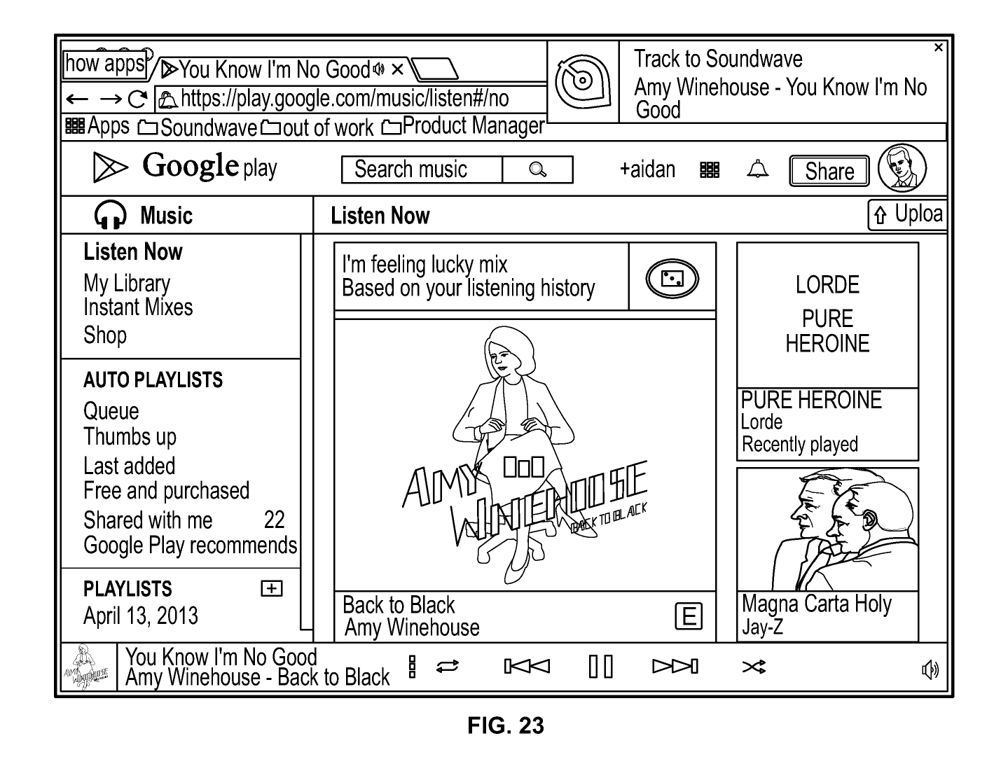

FIG. 23 is an example of how a song capture through a desktop player will look to a user of the service. In this case, the source of the desktop capture is from the Google Play Music platform. Thus the reader will see that at least one embodiment of the tracking system provides a more comprehensive and efficient approach to capturing music or other audio metadata on an electronic device. Furthermore, the tracking system and method described has the additional advantages in that:
it allows for the contextualization of this metadata by tracking the location, timestamp and user ID associated with data when it played;
it permits the tracking of such content across multiple platforms and devices and from a variety of music and/or audio sources;
it allows for an efficient way to display this information as a unified music feed using a graphical and textual interface to visualise this information to the end user;
it allows other users on the application to listen to the music or other audio metadata as quickly as it is played (both previews and full content);
it provides a mechanism for users to share such music or other audio metadata, irrespective of the source of the content, with other users within a social network or other conveyance system;
it allows for users to interact with the music or other audio metadata tracked and displayed on the unified music feed by rating the metadata;
it provides a mechanism whereby such metadata can be aggregated (by location, time, by user ID or rating) to provide real-time analysis of music or audio is the most played in a location, most liked or disliked, most played over a specific timeframe or most played by a specific user; and
it provides for a more efficient way to discover new music.

While the above description contains many specificities, these should not be construed as limitations on the scope, but rather as an exemplification of one or several embodiments thereof. Many other variations are possible. For example, cloud lockers that store music can also be tracked using a different embodiment of the system and such platforms are likely to become more and more common as storage moves away from hardware to the cloud. Thus, a further embodiment could add cloud lockers of music as another source of metadata which can also be displayed, consumed and/or shared by the end user. Accordingly, the scope should be determined not by the embodiments illustrated, but by the appended claims and their legal equivalents.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. An apparatus comprising:
at least one processor;
at least one memory including computer program code, the at least one memory and the computer program code configured to, with the at least one processor, cause the apparatus to perform tracking and capturing music content or other audio metadata in real-time on an electronic device.

2. An apparatus of claim 1, wherein the at least one processor and the at least one memory are further configured to initiate:
determination of at least a user ID, location and/or timestamp or such other predetermined information associated with playing of such content and the determination of a threshold information to be appended to the metadata as the content or metadata is captured.

3. An apparatus of claim 1 wherein the threshold information comprises a preset period of time in which an audio file is played to indicate that a user has listened to at least a portion of the audio file.

4. An apparatus of claim 1, wherein the at least one processor and the at least one memory are further configured to initiate:
receiving of first event metadata together with the contextualization of at least the user ID, location and/or timestamp and substantially display the information in a text and/or graphical form.

5. An apparatus of claim 4, wherein the first event metadata is received and stored from a number of sources selected from one or more of the following:
native music players, third party players, streaming services, music video services, cloud lockers and internet radio in response to a choice by a user to play such music or other audio metadata on their preferred music player.

6. An apparatus of claim 5, wherein the at least one processor and the at least one memory are further configured to track the songs played on a iPhone native music player.

7. An apparatus of claim 1, wherein a playlist or top played songs can be aggregated and displayed based on a user's stated predetermined preference.

8. An apparatus of claim 1, wherein any music or audio metadata is configured to be rated by a user.

9. An apparatus of claim 1, wherein any such music or audio metadata is configured to be shared by a user on a social network or other conveyance system or network.

10. An apparatus of claim 1, wherein the content comprises at least one of audio, video, image, book or game information.

11. An apparatus of claim 1, wherein a first event metadata and a second event metadata comprises one or more of an event type, user identification, content identifier, content duration, content metadata, time stamp, and location of a user device.

12. An apparatus to perform tracking music content or other audio metadata in real-time on an electronic device comprising:
means for initiating determination whether a song or video played has been synchronised and/or played previously; and
based on the determination of whether that song or video has been synchronised or played before, a means for initiating storage of data that indicates the number of times that song or video has been played by a user.

13. A computer implemented method to perform tracking music content or other audio metadata in real-time on an electronic device, the method comprising:
initiating determination whether a song or video played has been synchronised and/or played previously; and
based on the determination of whether that song or video has been synchronised or played before, initiating storage of data that indicates the number of times that song or video has been played by a user.

14. A storage medium comprising program instructions for causing a computer to perform a method of:
initiating determination whether a song or video played has been synchronised and/or played previously; and
based on the determination of whether that song or video has been synchronised or played before, initiating storage of data that indicates the number of times that song or video has been played by a user.
